(19) United States
(12) Patent Application Publication
(10) Pub. No.: US 2005/0162643 A1
(43) Pub. Date: Jul. 28, 2005

(54) Automotive fuel tank inspection device

(76) Inventor: Thomas Karpen, Skaneateles, NY (US)

Correspondence Address: WALL MARJAMA & BILINSKI, 101 SOUTH SALINA STREET, SUITE 400, SYRACUSE, NY, 13202, US

(21) Appl. No.: 10/762,947

(22) Filed: Jan. 22, 2004

(51) Int. Cl. G01N 21/88

(52) U.S. Cl. 356/237.1

(57) ABSTRACT

An inspection device for inspecting the interior of an enclosed volume. The inspection device includes a display and an imaging probe coupled to the display. The imaging probe includes a first end having imaging optics. A protective sleeve is removably engageable with the imaging probe, wherein the first end of the imaging probe is movable with respect to a distal end of the protective sleeve.

### 1. FIELD OF THE INVENTION

The present invention relates generally to an inspection devices and particularly to visual inspection devices suitable for inspecting fuel tanks such as those found in automobiles and other vehicles.

### 2. BACKGROUND OF THE INVENTION

Millions of automobiles and other wheeled vehicles cross national borders every year. Vehicular fuel tanks are often used by those seeking to smuggle illicit goods across borders. To combat this smuggling, customs and law enforcement officials employ inspection devices, such as for example, videoscopes, to inspect the interior of fuel tanks for contraband.

Automotive fuel tanks typically consist of a tank having an interconnected filler tube or neck. The filler neck typically includes a flapper valve and a rollover valve, both of which are usually biased to snap shut. Visual inspection of the interior of the fuel tank using a remote inspection device, such as a borescope, typically requires inserting an optical probe into the filler neck, passing the probe through the flapper valve and into the fuel tank body. The optical probe typically includes an insertion tube having imaging optics disposed at a distal end thereof. Passing the probe through the flapper valve necessitates pushing the flapper valve open. Typically, the optics that are disposed at the end of the probe are relatively fragile, and unsuited for pushing the flapper valve open. Furthermore, the probes may become snagged on the flapper valve, hindering both its insertion and removal. Thus, conventional optical probes encounter difficulties when used to inspect automotive fuel tanks for contraband.

One approach to overcome the above stated problem involves inserting a funnel or tube into the filler neck and using the end of the funnel or tube to open the flapper valve and rollover valve. The optical probe is then fed into the funnel and hence into the interior of the fuel tank. There are a number of drawbacks to this approach. A first drawback is that the inspector operating the video probe must also carry around a funnel or tube in addition to the probe video apparatus. Secondly, the funnel or tube is separate from the probe and can be removed independent of the probe, thereby allowing the flapper valve or the rollover valve to come into contact with the optical probe. As previously noted, the distal or optical end of the video probe is a relatively delicate optical instrument that is ill suited for making contact with either the flapper valve or the rollover valve. In particular, the pinching of the probe by the closing action of either the flapper valve of the rollover valve may damage the optical probe.

### SUMMARY OF THE INVENTION

In one embodiment, the present invention includes a vehicular fuel tank inspection device. The fuel tank inspection device includes a handset having a display. The fuel tank inspection device further includes a guide tube coupled to the handset as well as an elongated flexible probe that carries imaging optics at a distal end thereof coupled to the handset. The elongated flexible probe is at least partially disposed within the guide tube and is movable between a first position and a second position with respect to the guide tube, whereby the distal end is movable into and out of the guide tube, so as to prevent the flapper valve or the roll over valve from pinching the flexible probe and damaging the flexible probe.

According to another embodiment, the present invention includes a device for inspecting a tank having a filler tube that includes a flapper valve. The device includes a handset having a display and a probe that is coupled to the handset. The probe is defined by a first end having imaging optics, the imaging optics providing a field of view of a target or object wherein images of objects within the field of view are shown on the display. The device further includes a guide tube coupled to the handset. The guide tube defines a longitudinal passageway and is disposed about the probe such that the guide tube is slideable with respect to the probe, and in which the first end may be selectively extended from and retracted into the guide tube.

According to yet another embodiment, the present invention includes an inspection device for inspecting the interior of an enclosed volume. The inspection device includes a display and a probe coupled to the display. The probe includes a first end having imaging optics. The inspection device further includes a protective sleeve removably engageable with the probe, whereby the first end is movable with respect to a distal end of the protective sleeve.

According to yet another embodiment, the present invention relates to a method of inspecting a vehicular fuel tank. The method further includes the steps of inserting a guide tube of a remote video inspection device into a fuel tank, moving an elongated flexible probe of said remote video inspection device to a first position, whereby the distal end of said probe is positioned external to the guide tube. The method further includes the step of inspecting the interior of the fuel tank, and subsequently retracting the elongated flexible probe, the distal end being positioned inside the guide tube, and withdrawing the guide tube from the fuel tank.

### BRIEF DESCRIPTION OF THE DRAWINGS

FIG. 1 is a perspective view of an inspection device according the present invention;

FIG. 2 is a longitudinal cross sectional view of an guide tube useable in an inspection device according to the present invention;

FIG. 3 is a fragmentary side elevation view of a handset and insert/guide tube coupling of an inspection device according to the present invention;

FIG. 4 is a fragmentary side elevation view of an alternative embodiment of the present invention,

FIG. 5 is a series of cross sectional side elevation view of possible insertion end guide shapes for the guide tube of the present invention; and

FIG. 6 is perspective view of an alternative embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Whenever possible, the same reference numerals will be used throughout the drawings to refer to the same or like parts for clarity.

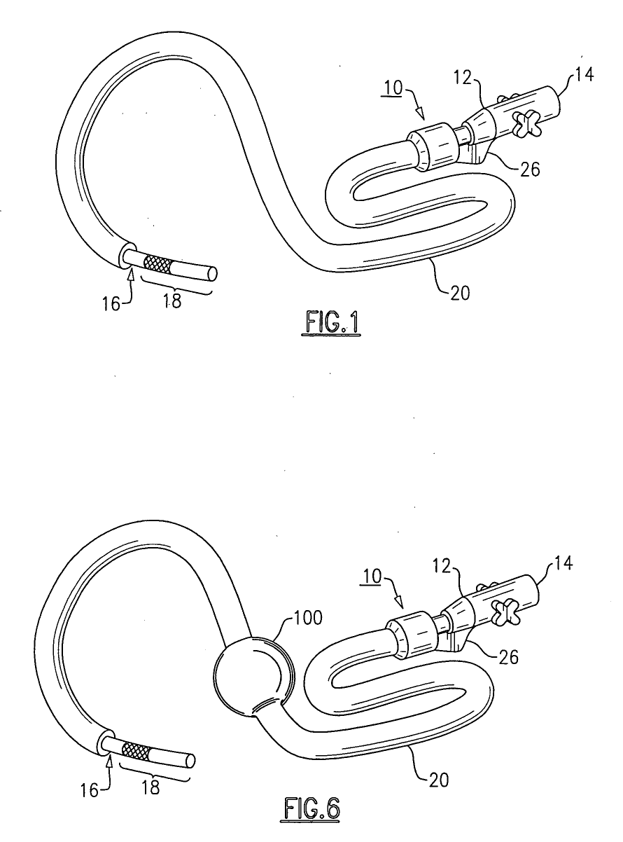

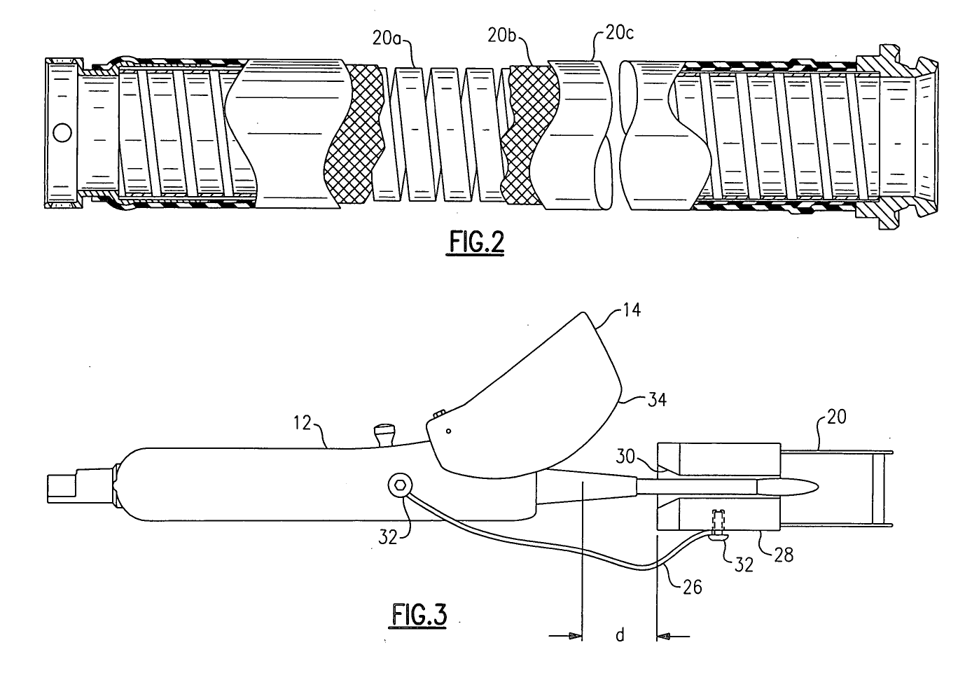

Referring to FIG. 1 there is shown a video probe fuel tank inspection device 10 having a handset 12, including a display 14 and an extending flexible insertion tube 16. One example of the described handset 12 is a VideoProbe® XL Pro™ borescope available from Everest-VIT, Inc. of Flanders, N.J. One end of the insertion tube 16 is equipped with a bendable neck region and imaging optics 18 that allow items within their field of view to be displayed on the display 14. The fuel tank inspection device 10 further includes a guide tube 20 coupled to the handset 12. The guide tube 20 is a flexible member having a stiffness similar to that of the insertion tube 16. The guide tube 20 is configured to resist crushing forces, such as for example by including a helical steel coil covered by a polymer coating, thereby protecting the insertion tube 16 and its associated imaging optics 18. The guide tube 20 may have a substantially annular cross section, although other cross sectional shapes may be preferred for specific operating environments. The interior of the guide tube 20 is sized to allow the insertion tube 16 to slide within the guide tube 20 without binding. In one embodiment, the guide tube 20 has an interior diameter of about 6 mm and an exterior diameter of about 10 mm. Preferably, the outer surface of the guide tube is a slick, non-binding surface such as, for example a surface coated with polyurethane, Teflon® or similar material. In one embodiment, the guide tube 20 is of similar construction to the insertion tube 16 of the videoscope. For example, as shown in FIG. 2, the guide tube 20 may include an helically wound spiral tube 20a, a flexible metallic braid layer 20b and a outer polyurethane layer 20c. An example of the construction of an insertion tube that is suitable for use as a guide tube 20 is found in U.S. Pat. No. 6,083,152 to Strong, which is herein incorporated by reference in its entirety. In an alternative embodiment, the guide tube 20 may be a polymeric tube.

As an additional safety feature, the automotive inspection device 10 of the present invention may be configured as a grounded element in order to prevent a static electrical discharge in the vicinity of fuel vapors. In one embodiment that incorporates this safety feature, the automotive fuel tank inspection device 10 is provided with a grounding wire for connection to a ground terminal (not shown).

In an other embodiment, such as that shown in FIG. 6, the guide tube 20 may include an external stop 100. In this embodiment, the guide tube is removably engageable with the fuel tank, such as, for example, the external stop may have a complimentary form factor so as to engage a predetermined region of the filler neck. The external stop 100 is configured to prevent the over insertion of the guide tube 20 and the insertion tube 16 into the interior volume to be inspected. The external stop 100, may be, for example a bulbous member that contacts the outside of the car or an exterior portion of the filler neck. The external stop 100 may be integrally formed with the guide tube 20 or may be a separate adjustable piece that is coupled to the guide tube 20. In one embodiment, the external stop is positioned such that the handset 12 cannot be positioned any closer than 18 inches from vehicle in normal use.

The guide tube 20 is slideably engageable with the insertion tube 16. The guide tube 20 is shorter than the insertion tube 16. The end of the guide tube 20 adjacent to the imaging end 17 of the insertion tube 16 is configured to facilitate insertion of the guide tube 20 into an automotive fuel tank. The profile of the insertion end of the guide tube 20 may, for example, be square, bullet shaped or tapered. Examples of suitable shapes for the insertion end of the guide tube 20 are shown in FIG. 5. The guide tube 20 may be of either an articulated or non-articulated design.

The guide tube 20 is moveable between at least a first position and a second position with respect to the insertion tube 16. FIG. 3 shows an embodiment of the present invention in which the guide tube 20 is coupled to the handset 12 by a flexible strap 26. The guide tube 20 includes a collar 28 configured to engage the connection between the insertion tube 16 and the handset 12. In the embodiment shown, the collar 28 includes a chamfered opening 30 for engaging the junction of the insertion tube 16 and the handset 12. The flexible strap 26 is preferably coupled to both the hand set 12 and the guide tube 20 by removable fasteners 32, such as, for example threaded fasteners. Using removable fasteners 32 allows the guide tube 20 to be readily replaced by the user if the guide tube 20 becomes damaged or too worn to perform properly.

The length of the flexible strap 26 is chosen such that when the guide tube 20 is a first position with respect to the insertion tube 16 the imaging end 17 of the insertion tube 16 is protected by the guide tube 20. In one embodiment, the flexible strap 26 is of sufficient length such that when it is fully extended the imaging end 17 of the insertion tube 16 is flush with the end of the guide tube 20. In an other embodiment, the flexible strap 26 is of sufficient length such that when it is fully extended the imaging end 17 of the insertion tube 16 is retracted within the end of the guide tube 20. In an other embodiment, the flexible strap 26 is of sufficient length such that when it is fully extended the imaging end 17 of the insertion tube 16 protrudes from the end of the guide tube 20.

The relative motion of the guide tube 20 in the opposite direction is constrained by the collar 28. When the handset 12 is moved so as to extend the imaging end 17 of the insertion tube 16 from the guide tube, the motion is limited by the collar 28 contacting contact a surface 34 of the handset 12. The flexible strap 26 is sized so that imaging end 17 of the insertion tube 16 may be extended from the guide tube a sufficient amount, such as, for example about three inches from the end of the guide tube 20 so as to allow the interior volume of the fuel tank to be visually inspected without moving the guide tube 20.

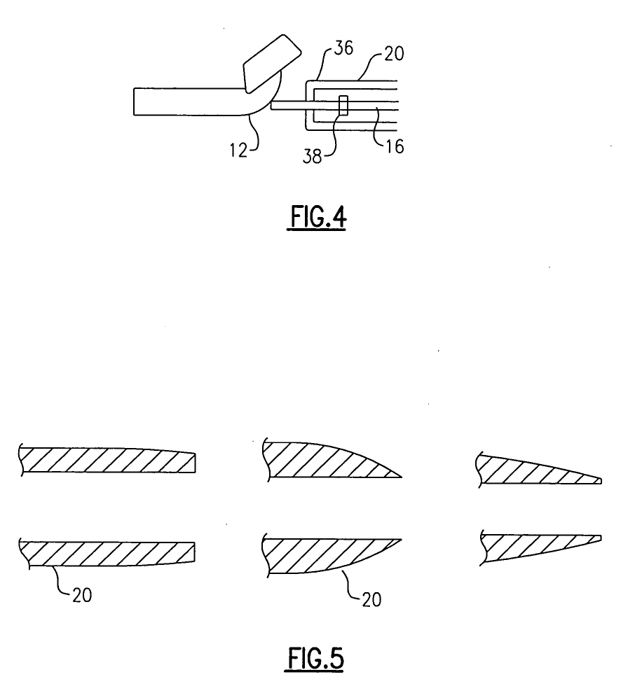

FIG. 4 illustrates an alternative embodiment of limiting the movement of the guide tube 20 with respect to the insertion tube 16. A stop collar 38 is coupled to the insertion tube 16 in at a predetermined distance from the handset 12. The stop collar 38 is disposed within the guide tube 20. The end 36 of the guide tube 20 closest to the handset is configured such that the end cannot move pass the stop collar 38. Thus, relative motion of the guide tube 20 with respect to the insertion tube 16 is limited to the distance between the stop collar 38 and the handset 12. When the end 36 of the guide tube 20 is adjacent to the stop collar 38 the imaging end 17 is protected by the insertion end 34 of the guide tube 20. When the end 36 of the guide tube 20 is adjacent to the handset 12 the bending neck portion of the insertion tube 16 is outside of the guide tube 20 and is free to be manipulated to inspect the interior volume of the fuel tank.

The embodiment of the present invention shown in FIG. 4 lends itself to an embodiment in which the insertion tube 16 is free to articulate and rotate independent of the guide tube 20. As will be appreciated by those skilled in the art, a wide variety of design choices for movement restricting stops are apparent after considerations of the examples contained herein and without departing from the teachings detailed above.

In operation, and before inserting the guide tube 20 into an automotive fuel tank, the imaging optics 18 at the end of the insertion tube 16 are positioned adjacent to the end of the guide tube 20 in such a manner that the imaging optics 18 and bending portion of the insertion tube 16 are protected. Typically this is accomplished by moving the handset 12 away from the automobile, thereby retracting the imaging end of the insertion tube 16 substantially within the insertion end 34 of the guide tube 20. A stop, such as, for example a flexible strap 26 or a stop collar 38 limits the amount that the imaging end 17 may be retracted into the guide tube 20. The position of the imaging end 17 with respect to the insertion end 34 of the guide tube 20 is preferably selected such that the imaging optics 18 are protected from damage without unduly limiting the ability of the imaging optics to provide images to the handset 12. For example, in some instances it may be preferable to have the imaging end either substantially flush with the insertion end of the guide tube 20 or only slightly withdrawn into the insertion end of 34 of guide tube 20. In this protected state, the guide tube 20 and insertion tube 16 are each inserted into the filler neck of the fuel tank. The guide tube 20 pushes open the flapper valve and thereby prevents the insertion tube 16 from contacting the flapper valve. The insertion end of the guide tube 20 is placed within the interior volume of the fuel tank. Without moving the guide tube 20, the imaging end and the bending portion of the insertion tube 16 are extended from the guide tube 20. The imaging end and the bending portion of the insertion tube 16 are extended from the guide tube 20 by moving the handset 12 towards the guide tube 20. Typically, the imaging end and the bending portion of the insertion tube 16 are extended about 3 inches from the insertion end of the guide tube 20.

Withdrawal of the insertion tube 16 and the guide tube 20 is accomplished by reversing the afore described procedure. First and without first moving the guide tube 20, the handset 12 is moved away from away from the guide tube 20, thereby retracting the imaging end of the insertion tube 16 substantially within the insertion end 34 of the guide tube 20. Once the imaging optics and bending neck are protected by the guide tube 20, the guide tube 20 and the insertion tube 16 are removed from the automotive fuel tank and its filler neck. During the removal, care is taken so that the imaging optics and bending neck region are not extended from the guide tube 20. Alternatively, the user may simply pull on the handset 12 which will result in the retraction on bending neck and imaging optics into the guide tube 20, and the removal of the entire assembly from the fuel tank and its filler neck.

It will be readily apparent to those of ordinary skill in the art of that the present invention may be adapted to other forms, such as, for example, commercially available videoscopes or to optical inspection devices that utilize optical fibers to transmit an image from the end of the insertion tube 16 to the handset or viewer.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. An vehicular fuel tank inspection device comprising:
a handset, said handset including a display;
a guide tube coupled to said handset;
an elongated flexible probe that carries imaging optics at a distal end thereof coupled to said handset, said elongated flexible probe being at least partially disposed within said guide tube, said elongated flexible probe movable between a first position and a second position with respect to said guide tube wherein said distal end is movable into and out of said guide tube.

2. The vehicular fuel tank inspection device of claim 1 further including:
a first stop, wherein the travel of said elongated flexible probe is limited in a first direction; and
a second stop, wherein the travel of said elongated flexible probe is limited in a second direction, which is different from the first direction.

3. The vehicular fuel tank inspection device of claim 1 wherein said guide tube is configured to be removably engageable with the vehicular fuel tank.

4. The vehicular fuel tank inspection device of claim 1, wherein said guide tube is replaceable with a second guide tube.

5. The vehicular fuel tank inspection device of claim 1 wherein the elongated flexible probe includes electronic image capturing circuitry.

6. The vehicular fuel tank inspection device of claim 1 wherein the imaging optics are in communication with the display via optical fibers.

7. The vehicular fuel tank inspection device of claim 1 further including an electrical grounding conductor.

8. A device for inspecting a tank having a filler tube that includes a flapper valve, said device comprising:
a handset, said handset including a display;
a probe coupled to said handset, said probe including a first end having imaging optics, said imaging optics having a field of view, whereby images of objects within the field of view are shown on said display; and
a guide tube coupled to said handset, said guide tube defining a passageway, said guide tube disposed about said probe whereby said guide tube is slideable with respect to said probe, whereby said first end may be selectively extended from and retracted into said passageway.

9. The device of claim 8 wherein said guide tube is configured to protect said first end of said probe when said first end is retracted into said passageway.

10. An inspection device for inspecting the interior of an enclosed volume, said inspection device comprising:
a display;
a probe coupled to said display, said probe including a first end, said first end including imaging optics; and
a protective sleeve removably engageable with said probe, whereby said protective sleeve is movable with respect to a said probe.

11. The inspection device of claim 10 further including a first stop, whereby said first stop limits the distance said first end may extend from said distal end.

12. The inspection device of claim 11 further including a second stop. whereby said second stop limits the distance said first end may be retraced into said distal end.

13. The inspection device of claim 10 wherein said protective sleeve has an outer diameter of about 10 mm.

14. The inspection device of claim 10 wherein said protective sleeve has in inside diameter of greater than about 3.9 mm.

15. The inspection device of claim 14 wherein said probe has an outer diameter of about 3.9 mm.

16. The inspection device of claim 10 wherein said probe has an outer diameter greater than about 10 mm.

17. The inspection device of claim 10 wherein said protective sleeve is an elastically deformable protective sleeve.

18. The inspection device of claim 10 wherein said protective sleeve and said probe include flexible members of substantially equal stiffness.

19. An inspection device comprising:
a handset;
a video probe coupled to said hand set and in communication with a display whereby an image captured by said video probe is displayed on said display; and
a guide tube coupled to said handset, said guide tube defining a longitudinal passageway, said guide tube disposed about said probe whereby said guide tube is slideable with respect to said probe, whereby said first end may be selectively extended from and retracted into said longitudinal passageway.

20. The inspection device of claim 19 wherein said video probe is rotatable relative to said guide tube.

21. A method of inspecting a vehicular fuel tank comprising the steps of:
providing an imaging device, said imaging device including:
a handset including a display;
an elongated flexible probe that carries imaging optics at a distal end thereof coupled to the handset; and
a guide tube, the guide tube defining an interior volume, wherein the distal end is disposed within said interior volume;
inserting the guide tube into the automotive fuel tank;
moving the elongated flexible probe to a first position, whereby the distal end is positioned outside the guide tube;
inspecting the interior of the automotive fuel tank;
moving the handset away from fuel tank thereby retracing the elongated flexible probe, whereby the distal end is positioned inside the guide tube; and
withdrawing the guide tube from the automotive fuel tank.

22. A method of inspecting a vehicular fuel tank comprising the steps of:
providing an imaging device, said imaging device including:
a handset;
an elongated flexible probe that carries imaging optics at a distal end thereof coupled to the handset; and
a guide tube, the guide tube defining an interior volume, wherein the distal end is disposed within said interior volume;
inserting the guide tube into the automotive fuel tank;
moving the elongated flexible probe to a first position, whereby the distal end is positioned outside the guide tube;
inspecting the interior of the automotive fuel tank;
moving the handset away from fuel tank thereby retracing the elongated flexible probe, whereby the distal end is positioned inside the guide tube; and
withdrawing the guide tube from the automotive fuel tank.
